(19) United States
(12) Patent Application Publication
(10) Pub. No.: US 2023/0009648 A1
(43) Pub. Date: Jan. 12, 2023

(54) DEVICE AND PROCESS FOR CONTINUOUS OHMIC HEATING OF FOODSTUFFS

(71) Applicant: Deutsches Institut für Lebensmitteltechnik e.V., Quakenbrück (DE)

(72) Inventors: Martin Stute, Quakenbrück (DE); Volker Heinz, Quakenbrück (DE)

(21) Appl. No.: 17/858,520

(22) Filed: Jul. 6, 2022

(30) Foreign Application Priority Data
Jul. 7, 2021 (DE) DE 102021207153.8

(51) Int. Cl. A23L 3/005; A22C 11/02; H05B 3/60; H05B 3/03; H05B 3/00

(52) U.S. Cl. CPC A23L 3/005; A22C 11/0209; H05B 3/60; H05B 3/03; H05B 3/0019

(57) ABSTRACT

A device for continuously heating foodstuffs includes a channel arranged to receive an electrically conductive liquid. Side walls of the channel include mutually opposite electrodes that are arranged in pairs which are connected to a current source. A first pair of mutually the opposite electrodes is arranged on the side walls of the channel at a distance along the channel. A second pair of mutually opposite electrodes is arranged in electrical contact with the interior of the channel. Each pair of electrodes is electrically connected to a respective one of separate secondary windings of a transformer of the current source. The secondary windings are arranged to be excited by at least one primary winding.

### PRIORITY CLAIM

This application claims priority under 35 U.S.C. § 119 and all applicable statutes and treaties from prior German Application DE 10 2021 207 153.8, filed Jul. 7, 2022.

### FIELD OF THE INVENTION

A field of the invention is preparation and heating foodstuffs by current flow, which is also generally referred to as ohmic heating. A particular application of the invention is to preparation and heating of sausages, including meat or vegetarian mass, as foodstuffs. Sausages may be attached to each other by constriction, for example twisting off or clipping, of a common continuous casing, or which may be separated.

It is known to hang sausage casings filled with sausage meat, in which casings the sausages linked together along the sausage casing, on racks for heating and to place these racks in a chamber heated with steam and/or smoke.

DE 10 2010 028 780 A1 describes a mold with spaced electrodes and walls covering the spacing of the electrodes for batchwise heating of food between the electrodes.

EP 3 478 088 B1 describes the piercing of needle-shaped electrodes arranged in groups into encased foodstuffs in order to heat them by introducing current.

EP 3 280 266 B1 describes the heating of sausage lying on segmented rotating cylindrical electrodes by applying current.

EP 2 741 616 B1 describes a device for ohmic heating of foodstuffs, in which the electrodes contacting a foodstuff are divided into segments and current in a controlled manner is applied to the electrode segments between which the lowest conductivity is measured.

### SUMMARY OF THE INVENTION

Devices and processes of the invention allow rapid heating of sausages and can be operated continuously, for example to cook filled sausage casings immediately after the filling. A preferred device for continuously heating foodstuffs includes a channel arranged to receive an electrically conductive liquid. Side walls of the channel include mutually opposite electrodes that are arranged in pairs which are connected to a current source. A first pair of mutually the opposite electrodes is arranged on the side walls of the channel at a distance along the channel. A second pair of mutually opposite electrodes is arranged in electrical contact with the interior of the channel. Each pair of electrodes is electrically connected to a respective one of separate secondary windings of a transformer of the current source. The secondary windings are arranged to be excited by at least one primary winding.

### BRIEF DESCRIPTION OF THE DRAWINGS

The invention is now described in more detail by way of examples and with reference to the figures, which schematically show in

FIG. 1 a current source of a device according to the invention and

FIG. 2 an overview of elements of a device according to the invention.

### DETAILED DESCRIPTION OF THE PREFERRED EMBODIMENTS

Preferred foodstuffs that can be prepared and heated are sausages attached to each other by their casing, filled with meat-containing sausage meat or vegetarian mass, the casing being electrically conductive, e.g. made of collagen, cellulose, optionally with fibers, optionally made of dielectric material with pores in which the filling is exposed and not covered by the casing. Preferred devices and processes provide continuous and rapid heating of the food, which heating is preferably uniform across the cross-section.

A preferred device for continuous heating of foodstuffs, in particular sausages, has a channel with mutually opposite side walls and a bottom, optionally with or without a lid, the channel extending from an inlet end to an outlet end which is opposite along its length, the channel being adapted to receive electrically conductive liquid, and at least a first pair of mutually opposite electrodes is arranged, in particular recessed, in the side walls and a second pair and optionally further pairs of mutually opposite electrodes are arranged, in particular recessed, at a distance therefrom along the channel, which electrode pairs are each in electrical contact with the channel interior, wherein preferably the first and the second pairs of electrodes and optional further pairs of electrodes are connected to a current source by respective separate secondary windings of a transformer, which are acted upon by a common primary winding, or consist thereof. The device may have, in addition to the first and second electrode pairs, further electrode pairs which are preferably each connected to separate secondary windings of the one common current source which are acted upon by, and are arranged to be energized from, one common primary winding.

The power source preferably includes a transformer, which is preferably a high-frequency transformer, connected to a generator, which transformer includes or consists of exactly one or at least one primary winding, e.g. at least two primary windings, and secondary windings coupled thereto, wherein one secondary winding in each case being in electrical contact with the electrodes of one of the pairs of electrodes. When the transformer includes at least two primary windings or consists thereof, each of said primary windings may be controlled by a separate power switch. Preferably, the transformer has at least one primary winding, for example at least two primary windings, which are coupled to at least two secondary windings such that the primary windings, preferably controlled by separate power switches, energize the secondary windings, or such that the one or at least two primary windings form a primary excitation for the secondary windings coupled thereto. In a transformer having at least two primary windings forming a primary excitation for the secondary windings coupled thereto, it is preferred that the primary windings are driven in phase by separate clock generators.

For example, the generator may be set up to apply alternating voltage, e.g., up to 1000 V, e.g., 400 to 700 V, e.g., 500 to 600 V, to the transformer at a frequency of 1 to 200 kHz, e.g., 20 to 50 kHz. The transformer may be set up, for example, to apply higher or lower voltages respectively to the pairs of electrodes spaced apart from each other along the length of the channel from its inlet end to its outlet end.

Preferably, the device has exactly one voltage source with a transformer, in particular a high-frequency transformer, which has a secondary winding electrically connected thereto for each pair of electrodes, the secondary windings preferably being energized by exactly one common primary winding.

The side walls of the channel are preferably arranged at a distance equal to the diameter of the foodstuffs multiplied by a factor of 1.1 to 1.5, or at a distance equal to the diameter of the foodstuffs plus 5 to 20 mm, e.g. plus 8 to 15 mm, and/or preferably planar and parallel to each other, further preferably with their height extension vertical. Therein, the diameter of the foodstuffs, which are in particular sausages, is determined in perpendicular to the longitudinal extension of the channel and/or in parallel to the cross-section of the channel, for example when the foodstuffs are arranged in the channel. In the case of elongated foodstuffs, in particular sausages, their diameter is determined in perpendicular to their longitudinal extension.

Optionally, the channel has a hold-down device mounted along the channel, e.g. at a distance from its bottom where the electrodes have their greatest extension from the bottom, and/or at a distance from the bottom corresponding to the filling level of the conductive liquid in the channel. The hold-down device may be a driven belt that moves from the inlet end toward the outlet end.

Preferably, the bottom of the channel is flat and is arranged horizontally. Optionally, the side walls of the channel have a height above the floor equal to a single diameter or an integer multiple of the diameter of the food plus 5 to 30 mm, e.g. plus 8 to 15 mm.

Further preferably, the spacing of the side walls changes along the channel (10), e.g. linearly, wherein the spacing of the side walls or the electrodes, resp., from the inlet end to the outlet end of the channel preferably increases. In this embodiment, the channel with the electrodes arranged in the side walls widens conically from its inlet end to the outlet end, in particular by a spacing of the side walls or the electrodes, resp., increasing linearly or arcuately from the inlet end to the outlet end. This embodiment has the advantage that the decreasing internal electrical resistance of the foodstuffs during heating is compensated for by the cross-section of the channel between the electrodes increasing from the inlet end to the outlet end. Thereby, heating can occur more uniformly along the channel.

Preferably, the device for the foodstuffs includes a conveying device arranged to convey the foodstuffs continuously along the channel. In particular for use for foodstuffs connected to one another, e.g. chains of sausages, a conveying device may be a traction device arranged at the outlet end of the channel, e.g. a rotationally driven wheel around which the foodstuffs connected to one another lie, or two conveyor belts or wheels driven in opposite directions which between them clamp the foodstuffs connected to one another.

A conveying device suitable in particular for conveying separated foodstuffs has a belt circulating along and below and/or above the channel from which push elements extend into the channel, which are arranged to move as the belt circulates along the channel from the inlet end towards the outlet end. These push elements push the foodstuffs along the channel in the direction of its outlet end and can be, for example, bars, grids or plates which extend over a portion of the cross-section of the channel.

Alternatively or additionally, a conveying device may be formed by a pump or a liquid supply which is arranged to introduce liquid into the channel at the inlet end and which is preferably arranged to move the liquid contained in the channel along the channel from its inlet end to the outlet end. Such a pump may, for example, be connected to the channel by a bleed conduit connected in the region of the outlet end and by an inlet conduit connected in the region of the inlet end, and may be arranged to withdraw liquid from the bleed conduit and press it into the inlet conduit.

In general, the channel preferably has an area of the bottom rising toward its outlet end in order to guide the foodstuffs out of the channel at the outlet end.

Optionally, the device has a cooling device which is set up to cool the liquid contained in the channel, in particular to cool liquid taken from a bleed conduit connected in the area of the outlet end outside the channel and to convey it into the channel through an inlet conduit connected in the area of the channel inlet. Optionally, the liquid to be cooled is introduced at the outlet end and/or via channel upper side/channel lid side and discharged at the channel inlet and/or at the channel bottom side.

Optionally, the device according to the invention is arranged downstream of a filling machine for sausage casings and/or upstream of a cooling system arranged downstream, which is set up to cool heated foodstuffs by sprinkling with water. Therein, it is preferred that the device includes a conduit which is arranged to conduct water emerging from the cooling system, with which the foodstuffs have been sprinkled, into the channel, e.g. via an inlet conduit connected in the region of the inlet end.

For optimum energy input, the conductivity of the liquid can be adjusted to match the conductivity of the food. In general, it is preferred that the conductive liquid has a conductivity that is about half to twice the conductivity of the foodstuff Therein, the conductivity of the foodstuff is its conductivity across its cross-section. Preferably, the conductive liquid is water, the conductivity of which is optionally adjusted by adding salt, in particular NaCl. Optionally, the device has a conductivity sensor, which is set up to measure the electrical conductivity of the liquid in the channel or in one of the conduits connected thereto, and further preferably a dosing device, controlled as a function of the conductivity sensor, for a salt or a salt solution and/or a dosing device, controlled as a function of the conductivity sensor, for water, which may be deionized water. Each of the dosing devices is, for example, controlled depending on the conductivity sensor to dose salt or a salt solution or water into the channel or into a conduit connected thereto, in order to set a predetermined conductivity of the liquid contained in the channel.

Presently, casings are generally tubular and with respect to sausages may also be referred to as sausage casings.

In the process, foodstuffs are heated by moving them, preferably at a constant speed, from the inlet end to the outlet end of a channel containing conductive liquid, while electric current is applied to at least one first pair of electrodes and at least one second pair of electrodes spaced therefrom along the channel, the electrodes of which are each arranged opposite each other in the side walls.

Optionally, the conductive liquid is discharged from the channel, cooled and reintroduced into the channel.

Preferably, following heating, the foodstuffs are moved out of the channel at the outlet end and sprinkled with cooling water in a cooling system, and at least part of the cooling water originating from the cooling system is then introduced into the channel, preferably in the region of its inlet end.

The foodstuffs are moved continuously along the channel by means of a conveying device, separated foodstuffs preferably by means of a conveying device which moves the liquid along the channel and/or by means of a conveying device which moves push elements along the channel. The foodstuffs may have a casing or a surface sufficiently solid in the liquid, formed of the mass of the foodstuff. The foodstuffs may be moved through the channel in an arrangement only one behind the other and/or in one layer, or in an arrangement of at least two layers of foodstuffs one above the other. In general, it is preferred that the foodstuffs in each layer, for example in one single layer or in layers arranged one above the other, are arranged only one behind the other and in a row and not side by side.

It has shown that the bottom and the side walls of the channel extending above it are preferably each flat, the bottom arranged horizontally and the side walls vertically. This is because it results in faster heating for sausages that are moved along the channel than for a concave bottom that is adapted to the diameter of the sausages, for example.

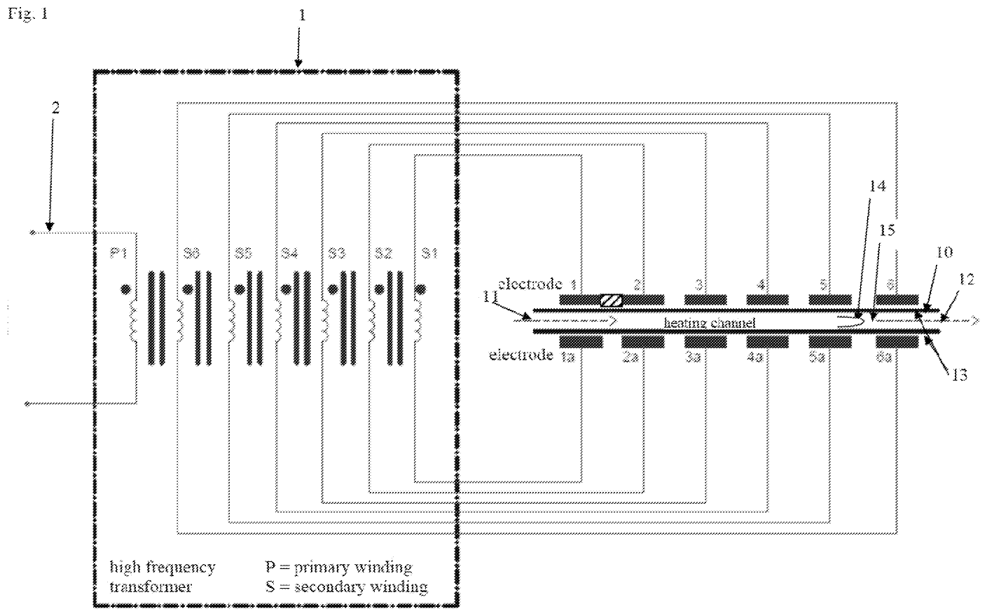

FIG. 1 shows a high-frequency transformer 1 having a primary winding P1 fed from the generator (at point 2), and containing magnetically coupled, at least two, secondary windings S, here exemplarily six, S1, S2, S3, S4, S5, S6. A channel 10 extending from its inlet end 11 to its outlet end 12 has electrodes 1 to 6, 1a to 6a, embedded in the side walls 13, forming respective pairs of electrodes 1, 1a and 2, 2a and 3, 3a and 4, 4a and 5, 5a and 6, 6a opposite to one another, each pair of electrodes of which being electrically connected to a respective one of the secondary windings S1 to S6. To the pairs of electrodes 1, 1a and 2, 2a and 3, 3a and 4, 4a and 5, 5a and 6, 6a different electrical powers each can be applied depending on the characteristics of the sausage meat, of the casing, of the conductive liquid and of the process speed.

Between the foodstuffs 14 and the electrodes 1, 1a and 2, 2a and 3, 3a and 4, 4a and 5, 5a and 6, 6a, as a conductive liquid 15 water is contained in the channel 10.

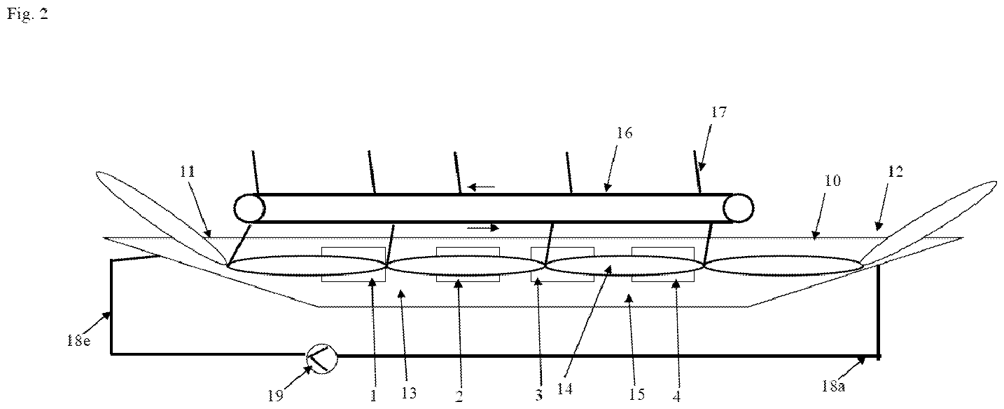

FIG. 2 shows a device with a channel 10 in side view and, above the channel, a conveying device in the form of a circulating belt 16 from which push elements 17 extend into the volume of the channel 10 to move foodstuffs 14 arranged therein from the inlet end 11 to the outlet end 12. Such a circulating belt 16 may, optionally without push elements 17, form a hold-down device.

Furthermore, there is shown an inlet for water as a conductive liquid connected in the region of the inlet end as an alternative or additional conveying device, and as an alternative or as an addition a pump 19 connected to an inlet conduit 18e in the region of the inlet end 11 is shown for conveying the conductive liquid to the outlet end. The pump 19 is connected to the channel 10 by a bleed conduit 18a connected in the region of the outlet end 12, so that the liquid 15 can be pumped in a circulating manner.

1. A device for continuously heating foodstuffs, comprising
a channel arranged to receive an electrically conductive liquid, mutually opposite electrodes are arranged in pairs on side walls of the channel and are connected to a current source, wherein
a first pair of the mutually opposite electrodes is arranged on the side walls at a distance along the channel,
a second pair of the mutually opposite electrodes is arranged in electrical contact with an interior of the channel, and wherein each of the pairs of electrodes is electrically connected to a respective one of separate secondary windings of a transformer of the current source and the secondary windings are arranged to be excited by at least one primary winding of the transformer of the current source.

2. The device according to claim 1, wherein the side walls are arranged vertically and the channel comprises a bottom which is flat and is arranged horizontally and connects the side walls.

3. The device according to claim 1, wherein the side walls are arranged at a spacing equal to the diameter of the foodstuff multiplied by a factor of 1.05 to 1.5.

4. The device according to claim 1, wherein the spacing of the side walls varies along the channel.

5. The device according to claim 4, wherein the spacing of the side walls widens conically from an inlet end to an outlet end.

6. The device according to claim 1, wherein the current source is configured to apply different electrical power to each of the pairs of electrodes.

7. The device according to claim 1, comprising, above and or below the channel, a conveying device comprising a belt driven to rotate along the channel, the conveying device having push elements that extend into the channel and are arranged to move along the channel from an inlet end towards and outlet end with rotation of the belt.

8. The device according to one claim 1, comprising a conveying device formed by a pump connected to the channel by a bleed conduit connected in a region of an outlet end and by an inlet conduit connected in the region of an inlet end, the pump being configured to bleed liquid from the bleed conduit and to press it into the inlet conduit.

9. The device according to claim 1, comprising a pulling device arranged as a conveying device at an outlet end of the channel, the pulling device comprising a rotationally driven wheel or wo conveyor belts or wheels driven in opposite directions arranged to clamp between them foodstuffs.

10. The device according to claim 1, comprising a cooling device arranged to cool liquid contained in the channel.

11. The device according to claim 10, wherein the cooling device is arranged to cool liquid bled from a bleed conduit connected in the region of an outlet end to outside the channel and to convey it into the channel through an inlet conduit connected in the region of an inlet end.

12. The device according to claim 10, wherein the cooling device is arranged to introduce cooling liquid at an outlet end and/or via a channel upper side and/or via a channel lid side, and to bleed cooling liquid at the channel inlet and/or at a channel bottom.

13. The device according to claim 1, comprising a cooling system arranged to cool heated foodstuffs by sprinkling with water, wherein the device has a conduit which is arranged to conduct water emerging from the cooling system, with which the foodstuffs have been sprinkled, into the channel by an inlet conduit connected in the region of an inlet end.

14. The device according to claim 1, comprising a conductivity sensor arranged to measure electrical conductivity of the liquid in the channel or in one of the conduits connected thereto, and at least one dosing device for salt, salt solution or water, which is controlled as a function of the conductivity sensor and is connected to the channel.

15. The device according to claim 1, wherein the transformer has two or more primary windings driven in phase by separate clock generators.

16. A process of producing foodstuffs comprising:
heating by application of electric current with a device according to claim 1, moving the foodstuffs by a conveying device through the channel with the channel being filled with conductive liquid from an inlet end to an outlet end, wherein the electric current is to the liquid by the first pair of mutually opposite electrodes and the second pair of mutually opposite electrodes.

17. The process according to claim 16, wherein the foodstuffs have a food mass filled in a casing and are attached to each other by the casing.

18. Process according to claim 16, wherein the foodstuffs are separated.
